(19) United States
(12) Patent Application Publication
(10) Pub. No.: US 2010/0178553 A1
(43) Pub. Date: Jul. 15, 2010

(54) ELECTRIC STORAGE DEVICE

(76) Inventor: Takashi Murata, Toyota-shi (JP)

Correspondence Address: KENYON & KENYON LLP, 1500 K STREET N.W., SUITE 700, WASHINGTON, DC, 20005, US

(21) Appl. No.: 12/376,669

(22) PCT Filed: Jan. 31, 2008
(86) PCT No.: PCT/IB08/00214

§ 371 Date: Feb. 6, 2009

(30) Foreign Application Priority Data
Feb. 1, 2007 (JP) 2007-023586

(51) Int. Cl. H01M 2/02; H01M 2/00; H01M 2/10

(52) U.S. Cl. 429/179; 429/163; 429/186

(57) ABSTRACT

A battery unit in which a battery case of a bipolar type battery is constructed of an elastic member is provided. The battery unit includes a reinforcement member that is internally integrated within the battery case to heighten the mechanical strength of the battery case.

### BACKGROUND OF THE INVENTION

1. Field of the Invention

The invention relates to an electric storage device in which an exterior member of an electric storage body is constructed of an elastic member.

2. Description of the Related Art

Common batteries vary in terms of their exterior members, including a battery whose exterior member is constructed of a metal sheet, a battery whose exterior member is constructed of a plastic sheet, a battery whose exterior member is constructed of a plastic sheet that is provided with a metal thin film layer in order to prevent gas permeation, etc. The metal material has good strength, but does not have good property of recovery (restoration) from deformation of the battery that generates heat at the time of charging or discharging, so that excessive load occurs on the exterior member if the cycle of deformation and recovery (restoration) is repeated. This also applies to the case where a plastic material is used as an exterior material.

Therefore, in conjunction with a technology disclosed in Japanese Patent Application Publication No. 06-267515 (JP-A-06-267515), a secondary battery whose exterior member is formed of a sheet that has rubber elasticity is proposed.

According to this construction, the exterior member can be elastically deformed according to the expansion or shrinkage of the battery that generates heat at the time of charging or discharging. Thus, an exterior member that is more excellent in the property of recovery (restoration) from deformation than plastics and metals.

Secondary batteries mounted as vehicle-driving power sources or auxiliary power sources in electric motor vehicles, hybrid motor vehicle, etc., receive vibrations and impacts in association with the running of the vehicles over the service life of the vehicles, that is, a long period of 10 to 15 years. Therefore, such secondary batteries need to be protected from impacts and vibrations.

However, if a secondary battery has a construction in which the exterior member is merely covered with a sheet that has rubber elasticity, there is a possibility that excessive load may be applied to the secondary battery due to impact or vibration associated with the running of the vehicle.

### SUMMARY OF THE INVENTION

Accordingly, the invention provides an electric storage device that is robust to vibration and impact while exploiting advantages of an elastic member that is excellent in the property of recovery (restoration) from deformation.

An electric storage device in accordance with an aspect of the invention is an electric storage device in which an exterior member of an electric storage body is constructed of an elastic member, and which includes a reinforcement member that is internally integrated with the exterior member to heighten mechanical strength of the exterior member.

In the electric storage device in accordance with the foregoing aspect, the electric storage body may be constructed by arranging a plurality of electric storage elements.

Furthermore, in the electric storage device in accordance with the foregoing aspect, the reinforcement member may be formed from a material that is higher in the mechanical strength than the elastic member.

Furthermore, in the electric storage device in accordance with the foregoing aspect, the reinforcement member may be formed from a metal or a resin.

Furthermore, in the electric storage device in accordance with the foregoing aspect, the reinforcement member may be formed by arranging a linear member in a shape of a net.

Furthermore, in the electric storage device in accordance with the foregoing aspect, the reinforcement member may be constructed of a sheet-shape member.

Furthermore, in the electric storage device in accordance with the foregoing aspect, the reinforcement member may be formed by linking a pipe-shape member into a rectangular shape.

Furthermore, in the electric storage device in accordance with the foregoing aspect, the reinforcement member may be formed by further providing a diagonal bracing.

Furthermore, the electric storage device in accordance with the foregoing aspect may further include a fastening fixture portion for fastening and fixing the electric storage device, and the fastening fixture portion may be formed so as to be integrated with the exterior member.

Furthermore, in the electric storage device in accordance with the foregoing aspect, the fastening fixture portion may be formed by using a portion of the exterior member.

Furthermore, in the electric storage device in accordance with the foregoing aspect, the fastening fixture portion may have a fastening hole for fastening the fastening member, and the fastening hole may be provided with a sleeve.

Furthermore, the electric storage device in accordance with the foregoing aspect may further include a fastening fixture portion for fastening and fixing the electric storage device, and the fastening fixture portion may be formed by a metal bracket.

Furthermore, in the electric storage device in accordance with the foregoing aspect, an electrode terminal of the electric storage body may be protruded outside the exterior member, and the reinforcement member may be provided so as not to interfere with the electrode terminal.

Furthermore, in the electric storage device in accordance with the foregoing aspect, a voltage detection terminal that detects a voltage of the electric storage element may be protruded outside the exterior member, and the reinforcement member may be provided so as not to interfere with the voltage detection terminal.

Furthermore, in the electric storage device in accordance with the foregoing aspect, the electric storage body may be for use in a vehicle. The electric storage body may be used as a vehicle-driving or auxiliary electric power source of a vehicle (e.g., an electric motor vehicle, a hybrid motor vehicle, or a fuel-cell motor vehicle).

Furthermore, in the electric storage device in accordance with the foregoing aspect, the elastic member may be made of a rubber.

According to the invention, it is possible to more reliably protect the electric storage body from impact and vibration while exploiting advantages of an elastic rubber that is excellent in the property of recovery (restoration) from deformation.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a longitudinal sectional view of a vehicle in which a battery unit in the invention is fixed to a floor panel;

FIG. 2 is an exploded perspective view of a battery unit in the invention;

FIG. 3 is an X-X′ sectional view of a bipolar type battery taken as indicated in FIG. 2;

FIG. 4 is a perspective view of a battery unit in the invention;

FIG. 5 is a perspective view of a battery unit 10 in the invention;

FIG. 6A is a Y-Y′ sectional view taken as indicated in FIG. 5;

FIG. 6B is a plan view of a metal bracket in the invention; and

FIGS. 7A to 7C are schematic diagrams of other embodiments of a reinforcement member.

### DETAILED DESCRIPTION OF EMBODIMENTS

Hereinafter, embodiments of the invention will be described.

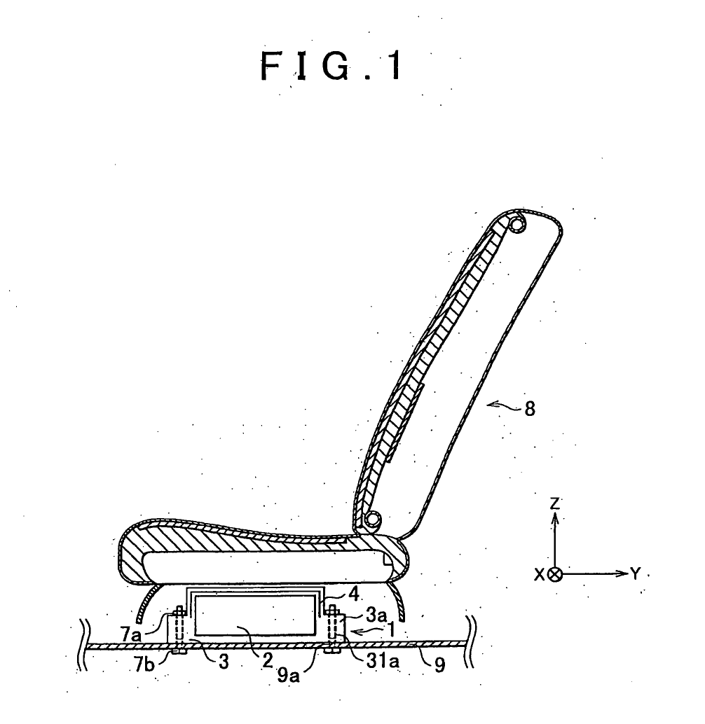

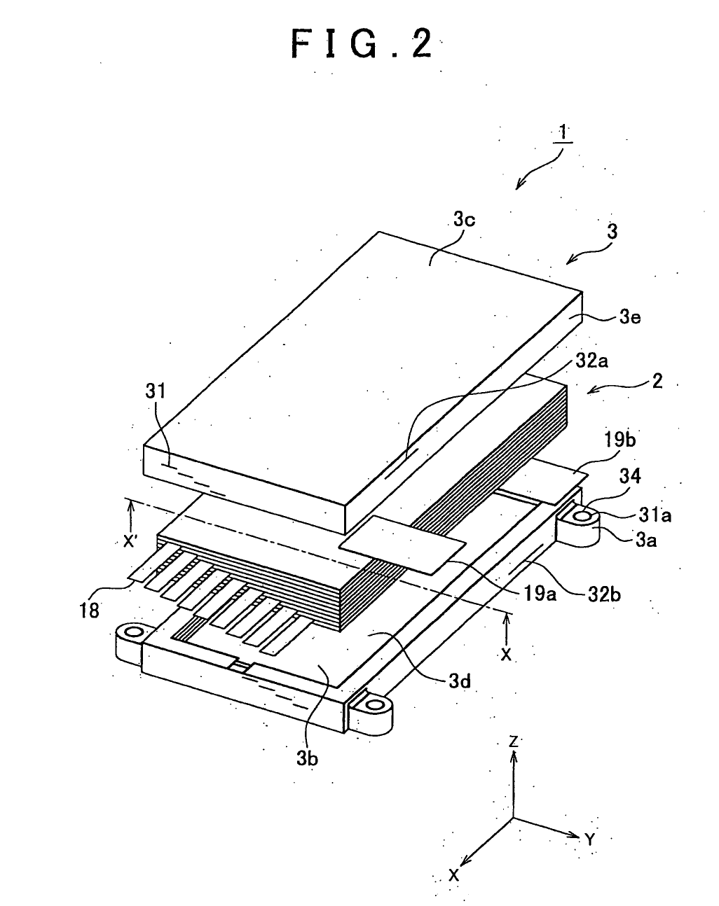

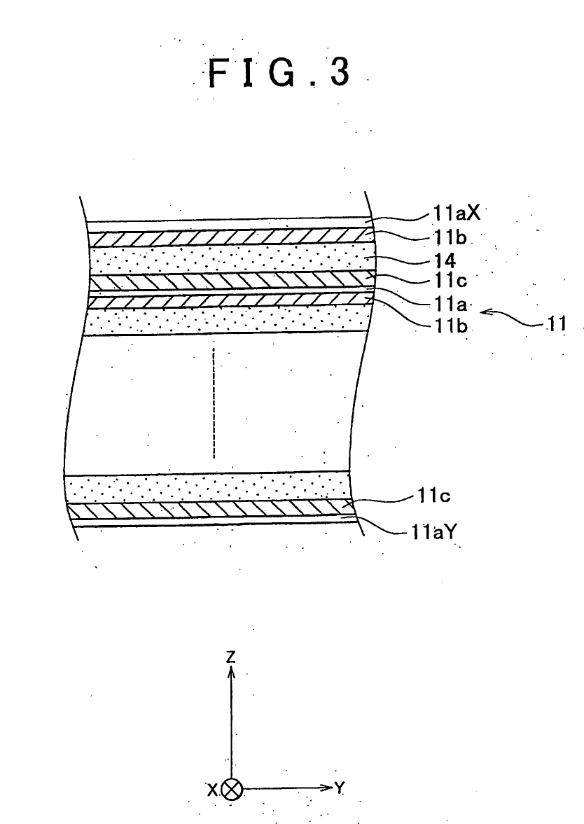

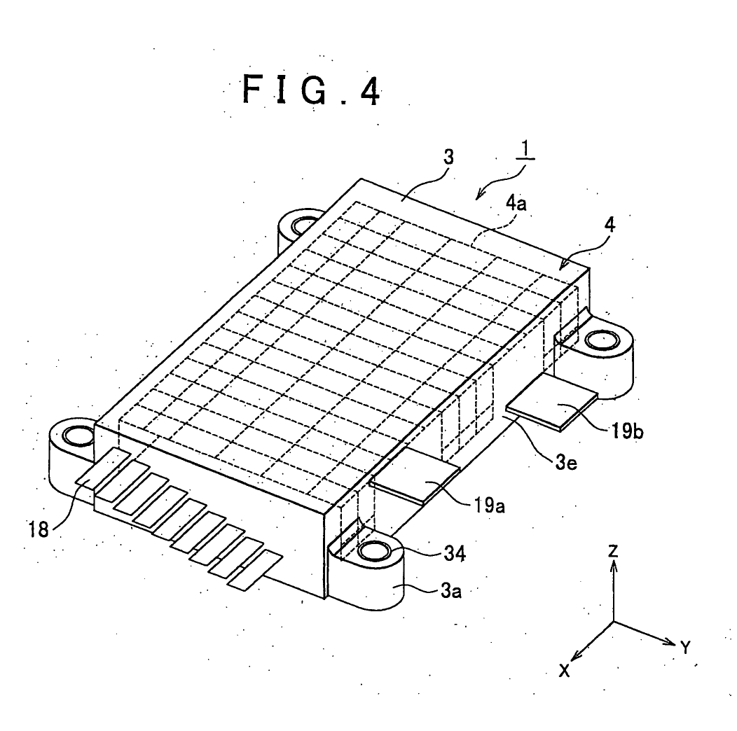

With reference to FIGS. 1 to 4, a battery unit (electric storage device) as a first embodiment of the invention will be described. FIG. 1 is a longitudinal sectional view of a vehicle in which a battery unit in the invention is fixed to a floor panel. FIG. 2 is an exploded perspective view of the battery unit in the invention. FIG. 3 is an X-X′ sectional view of a bipolar type battery taken as indicated in FIG. 2, and FIG. 4 is a perspective view of the battery unit in the invention.

A vehicular battery unit 1 as the first embodiment of the invention is a driving electric power source of a hybrid vehicle, and is fixed to a floor panel 9 below a navigator's seat (front passenger seat) 8.

The battery unit 1 is constructed of a bipolar type battery (electric storage body) 2, a battery case 3 (exterior member) that covers the bipolar type battery 2, and a reinforcement member 4 that is internally integrated with the battery case 3. The battery case 3 is formed from an elastic rubber. The reinforcement member 4 is formed by arranging reinforcement wires (linear members) in the shape of a net.

The battery case 3 has flange portions (fastening fixture portions) 3a that are formed integrally therewith. The battery unit 1 is fixed to the floor panel 9 by fastening a fastening nut (fastening member) 7a to a fastening bolt (fastening member) 7b inserted through a mounting hole (fastening hole) 31a of each flange portion 3a.

The reinforcement member 4 is internally integrated with the battery case 3, so that the bipolar type battery 2 can be protected from vibration and impact that occurs in association with the running of the vehicle. Besides, the battery case 3 is formed from an elastic rubber, so that the battery case 3 can elastically deform according to the thermal deformation of the bipolar type battery 2 that occurs at the time of charging/discharging.

Next, with reference to FIGS. 1 and 2, the battery unit of the first embodiment will be described in detail. The bipolar type battery 2, as shown in FIG. 3, has a construction in which a plurality of electrode bodies 11 are alternately stacked with solid electrolyte layers 14 interposed therebetween.

Each electrode body 11 has a current collector 11a, a positive electrode layer 11b formed on one of surfaces of the current collector 11a, and a negative electrode layer 11c formed on the other surface of the current collector 11a. That is, each electrode body 11 has a bipolar type electrode structure. Incidentally, the positive electrode layers 11b, the negative electrode layers 11c, and the solid electrolyte layers 14 disposed between the position and negative electrode layers 11b, 11c constitute electricity storage elements.

However, each of outermost-layer current collectors 11aX, 11aY positioned on the two opposite ends of the bipolar type battery 2 in the stacking direction has an electrode layer only on one surface thereof (the positive electrode layer on the electrode 11aX, and the negative electrode layer on the collector 11aY).

A positive terminal 19a and a negative terminal 19b for leading out current are electrically and mechanically connected to surfaces of the outermost-layer current collectors 11aX, 11aY (see FIG. 2). In addition, examples of the method of connecting the positive terminal 19a and the negative terminal 19b include welding.

Furthermore, voltage detection terminals 18 for detection voltage are electrically and mechanically connected to a surface of each electrode body 11 that extends in the sheet thickness direction. The voltage detection terminals 18 are connected to positions on the bipolar type battery 2 that are different from each other in a direction (Y axis direction) orthogonal to the stacking direction of the battery 2. More specifically, the voltage detection terminals 18 are arranged diagonally in the direction of the Z axis so as to be gradually shifted in position in the direction of the Y axis (see FIG. 2). Thus, since the positions of the extraction of the voltage detection terminal 18 are made different from each other in the Y axis, it becomes easy to connect wires to the voltage detection terminal 18. In addition, examples of the method of connecting the voltage detection terminals 18 may include welding.

Each of the positive electrode layers 11b and the negative electrode layers 11c contains an active material that corresponds to the positive electrode or the negative electrode. Besides, the electrode layers 11b, 11c contain an electroconductive auxiliary material, a binder, a high-molecular gel electrolyte for heightening the ion conductivity, a high-molecular electrolyte, an additive, etc. according to need.

The positive electrode active material to be used may be, for example, a composite oxide of lithium and a transition metal. Concretely, there are Li.Co-based composite oxides, such as LiCoO₂ and the like, Li.Ni-based composite oxides, such as LiNiO₂ and the like, Li.Mn-based composite oxides, such as spinel LiMn₂O₄ and the like, and Li.Fe-based composite oxides, such as LiFeO₂ and the like. In addition, examples of the positive electrode active material also include phosphate compounds and sulfated compounds of lithium and transition metals, such as LiFePO₄ and the like, transition metal oxides and sulfides, such as V₂O₅, MnO₂, TiS₂, MoS₂, MoO₃, etc., and PbO₂, AgO, NiOOH, etc.

On the other hand, the negative electrode active material to be used may be; for example, a metal oxide, a lithium-metal composite oxide, or carbon.

The solid electrolyte layer 14 to be used may be a high-molecular solid electrolyte or an inorganic solid electrolyte. The high-molecular solid electrolyte to be used may be, for example, polyethylene oxide (PEO), polypropylene oxide (PPO), or copolymers thereof. This high-molecular solid electrolyte contains a lithium salt for securing ion conductivity. The lithium salt to be used may be, for example, LiBF₄, LiPF₆, LiN(SO₂CF₃)₂, LiN(SO₂C₂F₅)₂, or mixtures thereof.

As shown in FIG. 2, the battery case 3 is constructed of an upper wall portion 3c, a lower wall portion 3d, and a side wall portion 3e. Inside the battery case 3, a reception portion 3b for accommodating the bipolar type battery 2 is formed.

In each of lengthwise side wall portions 3e (along the XZ plane) of the battery case 3, two opposite end portions thereof in the X axis direction each have a flange portion 3a (see FIGS. 2 and 4). Each of the flange portions 3a has a mounting hole 31a that extends in an up-down direction of the vehicle (the Z axis direction). Each mounting hole 31a has therein a metallic material-made tubular sleeve 34 that has been pressed in.

As shown in FIG. 1, the floor panel 9 is provided with threaded holes 9a that extend in the direction of the sheet thickness of the floor panel 9. From the back side of the floor panel 9, fastening bolts 7b are fastened to the threaded holes 9a. The length of the fastening bolts 7b is set greater than the sheet thickness of the floor panel 9, and therefore the fastening bolts 7b extend out into a region on the cabin side (above the floor pant 9).

By inserting the fastening bolts 7b into the sleeves 34 and fastening the fastening nuts 7a to the distal end portions of the fastening bolts 7b extending out of the sleeves 34, the battery unit 1 can be fixed to the floor panel 9.

In the foregoing construction, by pressing the sleeves 34 into the mounting holes 31a made of an elastic rubber, the fastening torque of the fastening nuts 7a can be secured.

As shown in FIG. 2, a lengthwise side wall portion 3e (along the XZ plane) of the battery case 3 has positive and negative terminal-purpose slits 32a, 32b for extracting the positive terminal 19a and the negative terminal 19b to the outside of the battery unit 1.

Furthermore, shorter side wall portions 3e (along the XY plane) of the battery case 3 each have a plurality of detection terminal-purpose slits 31 for extracting the voltage detection terminals 18 to the outside of the battery unit 1.

The elastic rubber constructing the battery case 3 may be either natural rubber or synthetic rubber, and is preferably a rubber that is electrochemically stable without losing rubber elasticity over a wide range of temperature and that does not dissolve in organic solvents. Concretely, polybutadiene rubber, polyisoprene rubber, polychloroprene rubber, styrene-butadiene rubber, butyl rubber, silicon rubber, butadiene acrylonitrile rubber, acrylic rubber, fluororubber, etc. can be used.

Since the battery case 3 is constructed of an elastic rubber, the battery case 3 can be elastically deformed according to the thermal deformation of the bipolar type battery 2 that occurs at the time of charging/discharging. This prevents the occurrence of a crack in the battery case 3, and more reliably seals in the bipolar type battery 2.

As shown in FIG. 4, the battery case 3 has an internally integrated reinforcement member 4. The reinforcement member 4 can be formed from a metal, a resin or the like that is higher in mechanical strength (rigidity) than the elastic rubber (battery case).

In the first embodiment, the reinforcement member 4 is formed by arranging reinforcement wires 4a having higher mechanical strength than the elastic rubber in the shape of a net, and the reinforcement member 4 is internally integrated within the upper wall portion 3c and portions of the side wall portions 3e of the battery case 3 so that the reinforcement member 4 does not interfere with the positive terminal 19a, the negative terminal 19b, or the voltage detection terminals 18.

Since the reinforcement member 4 is internally integrated within the battery case 3, the bipolar type battery 2 can be protected for a long time (the service life years of the vehicle), for example, from vibrations and impacts that occur in association with the running of the vehicle.

The battery unit 1 can be manufactured in the following method. Firstly, the bipolar type battery 2 and the reinforcement member 4 are set in a mold (not shown), and a liquid-state elastic rubber is poured into the mold. Incidentally, in a state in which the bipolar type battery 2 are set in the mold, the positive terminal 19a, the negative terminal 19b and the voltage detection terminal 18 are protruded to the outside of the mold.

Therefore, the elastic rubber poured into the mold fills the interior of the mold in such a manner as to avoid the positive terminal 19a, the negative terminal 19b and the voltage detection terminal 18 that are protruded. Therefore, the positive electrode-purpose slit 32a, the negative terminal-purpose slit 32b and the detection terminal-purpose slits 31 for extracting the positive terminal 19a, the negative terminal 19b and the voltage detection terminal 18 to the outside of the battery case 3 can be formed simultaneously with the pour of the elastic rubber (simultaneously with the molding of the battery case 3).

Incidentally, the mold has a shape portion that corresponds to the flange portion 3a. Therefore, the battery case 3 and the flange portion 3a can be integrally formed.

Thus, according to the first embodiment, at the time of injection molding of the battery unit 1 in a mold, the positive electrode-purpose slit 32a, the negative terminal-purpose slit 32b and the detection terminal-purpose slits 31 as well as the flange portions 3a can be simultaneously formed. This eliminates the need for the operation of attaching the flange portions 3a or forming the positive electrode-purpose slit 32a, the negative terminal-purpose slit 32b and the detection terminal-purpose slits 31, so that the battery unit 1 can be efficiently manufactured. Besides, since the positive terminal 19a and the negative terminal 19b are protruded to the outside of the battery case 3, the extraction of electric current becomes easy. Therefore, since the periphery of the bipolar type battery 2 is covered with the elastic rubber, the positional deviation of the electric storage elements can be prevented.

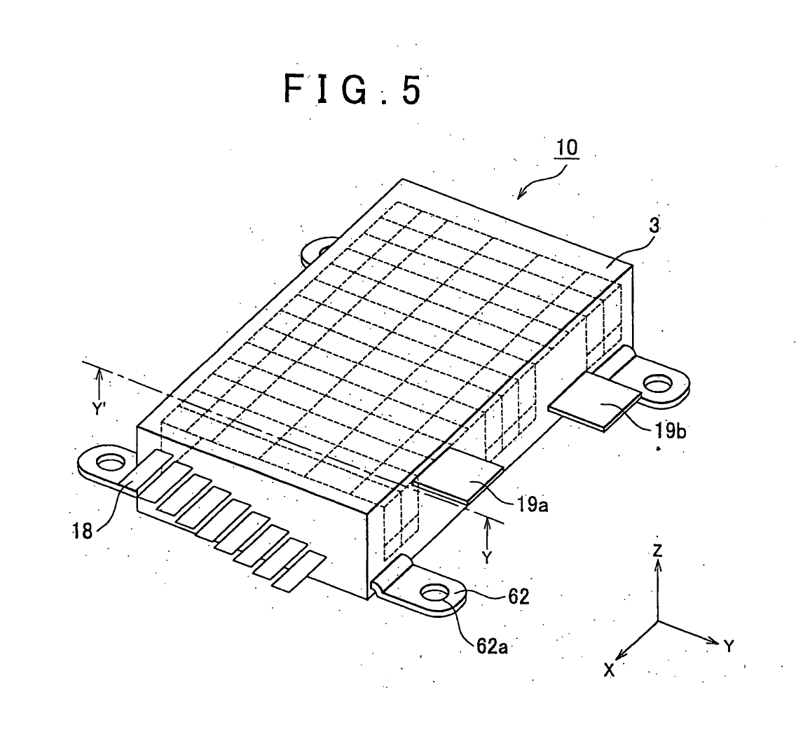

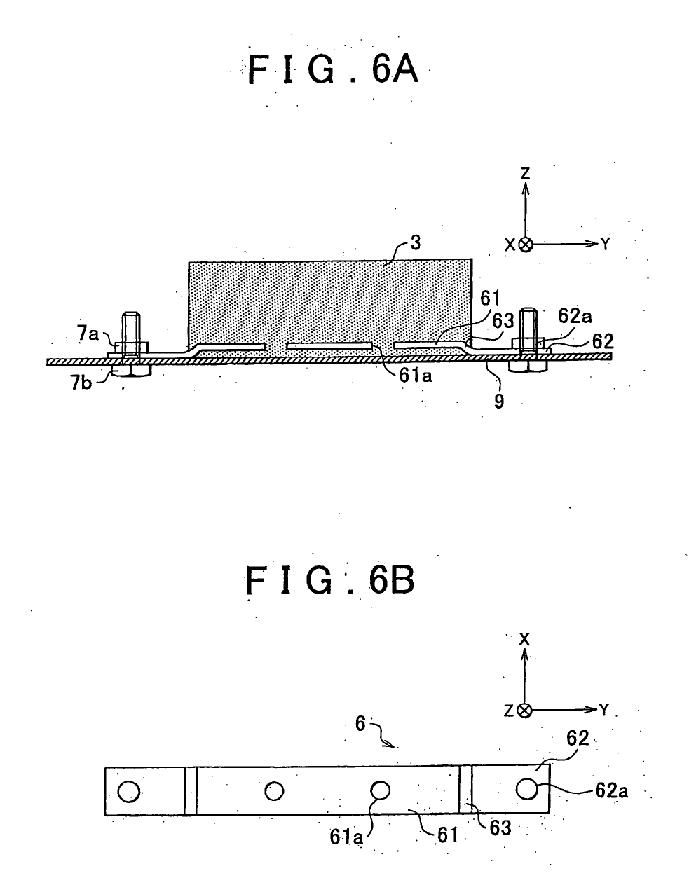

With reference, to FIGS. 5, 6A and 6B, a second embodiment of the invention will be described. FIG. 5 is a perspective view of a battery unit 10 in the second embodiment. FIG. 6A is a Y-Y′ sectional view as indicated in FIG. 5. FIG. 6B is a plan view of a metal bracket 6. The same component elements as those in the first embodiment are assigned with the same reference characters, and detailed descriptions thereof are omitted.

The metal bracket 6 is constructed of a bracket main body portion 61 disposed within the battery case 3, and bracket fixture portions 62 disposed outside the battery case 3. The bracket main body portion 61 and the bracket fixture portions 62 are interconnected via bent portions 63 that are bent downward from two opposite end portions of the bracket main body portion 61 that are opposite in the lengthwise direction thereof.

Each of the bracket fixture portions 62 has a mounting hole 62a. In the mounting hole 62a, a fastening bolt 7b extends from the back side of the floor panel 9, and is fastened. As in the first embodiment, by fastening a fastening nut 7a to each fastening bolt 7b from above the floor panel 9, the battery unit 10 can be fixed to the floor panel 9.

The bracket main body portion 61 has two opening portions 61a that allow an elastic rubber to pass therethrough. The battery unit 10 can be manufactured by setting the bipolar type battery 2, the reinforcement member 4 and the metal bracket 6 in a mold and pouring a liquid-state elastic rubber (the elastic rubber that is a material of the battery case 3) into the mold.

At this time, the elastic rubber poured into the mold passes through the opening portions 61a of the bracket main body portion 61, and flows to below the bracket main body portion 61, so that the elastic rubber above the bracket main body portion 61 and the elastic rubber below the bracket main body portion 61 are connected via the elastic rubber present within the opening portion 61a.

According to the foregoing construction, if external force is applied to the battery unit 10 in a planar direction (along the XY plane), the Metal bracket 6 contacts the elastic rubber provided within the opening portion 61a, so that the positional deviation of the metal bracket 6 can be prevented. Besides, the second embodiment can achieve substantially the same effects of the first embodiment.

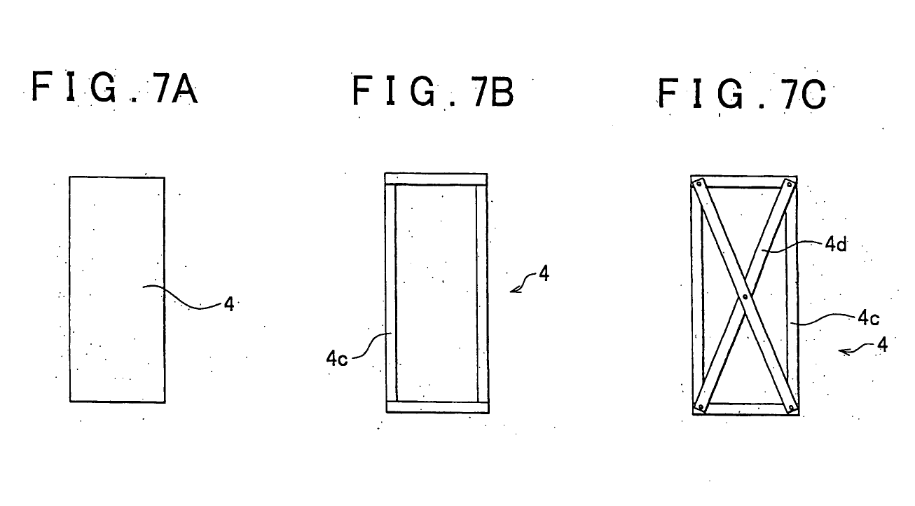

Although in the foregoing embodiments, the reinforcement member 4 is formed by arranging the reinforcement wires 4a in the shape of a net, the reinforcement member 4 may also be constructed as shown in FIGS. 7A to 7C. Specifically, as shown in FIG. 7A, a reinforcement member 4 constructed of a metal sheet may be internally integrated within the battery case 3.

Furthermore, it is also possible to use a frame-like reinforcement member 4 (see FIG. 7B) formed by linking a plurality of metal pipes 4c so as to form a rectangular shape, or a reinforcement member 4 (see FIG. 7C) in which diagonal braces 4d are added to the construction shown in FIG. 7B.

Furthermore, the reinforcement member 4 may be internally integrated at any positions in the battery case 3 as long as the reinforcement member 4 does not interfere with the positive terminal 19a, the negative terminal 19b or the voltage detection terminals 18. For example, the reinforcement member 4 may be internally integrated within the lower wall portion 3d of the battery case 3.

The battery unit 1, 10 may be disposed between the driver's seat and the navigator's seat, or below the rear luggage compartment, or the like. Furthermore, since the bipolar type battery 2 is high in heat resistance, the bipolar type battery 2 may also be disposed in the engine compartment. Although vibration is stronger in the engine compartment than in the foregoing portion below the seat, the bipolar type battery 2 in the invention can be effectively protected from vibrations since the reinforcement member 4 is internally integrated within the battery case 3.

Although the embodiments have been described in conjunction the bipolar type battery as an example, the invention can also be applied to a secondary battery (electric storage device) that is not of the bipolar type. A secondary battery that is not of the bipolar type has, for example, a construction in which a current collector is constructed of two different metals, and in which an electrode member in which a side surface of the current collector is provided with a positive electrode layer and the other side surface is provided with a negative electrode layer is used. For example, the invention is also applicable to a lithium-ion battery that employs an electrode member in which a positive electrode layer is formed on an aluminum metal and a negative electrode layer is formed on copper.

Furthermore, the invention is also applicable to an electric double-layer capacitor as an electric storage device. This electric double-layer capacitor is formed by alternately superimposing positive electrodes and negative electrodes with separators disposed therebetween.

In this electric double-layer capacitor, for example, aluminum foil may be used as a current collector, and an active carbon may be used as the positive electrode active material and the negative electrode active material, and a porous material formed of polyethylene or the like may be used as a separator.

Furthermore, a battery assembly may also be provided by juxtaposing a plurality of battery units 1, 10 in the longitudinal direction of the vehicle.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are example, other combinations and configurations, including more, less or only a single element, are also within the spirit and scope of the invention.

1. An electric storage device in which an exterior member of an electric storage body is constructed of an elastic member, comprising a reinforcement member that is internally integrated with the exterior member to heighten mechanical strength of the exterior member.

2. The electric storage device according to claim 1, wherein the electric storage body is constructed by arranging a plurality of electric storage elements.

3. The electric storage device according to claim 1, wherein the reinforcement member is formed from a material that is higher in the mechanical strength than the elastic member.

4. The electric storage device according to claim 3, wherein the reinforcement member is formed from a metal.

5. The electric storage device according to claim 3, wherein the reinforcement member is formed from a resin.

6. The electric storage device according to claim 3, wherein the reinforcement member is formed by arranging a linear member in a shape of a net.

7. The electric storage device according to claim 3, wherein the reinforcement member is constructed of a sheet-shape member.

8. The electric storage device according to claim 3, wherein the reinforcement member is formed by linking a pipe-shape member into a rectangular shape.

9. The electric storage device according to claim 8, wherein the reinforcement member is formed by further providing a diagonal bracing.

10. The electric storage device according to claim 1, further comprising a fastening fixture portion for fastening and fixing the electric storage device,
wherein the fastening fixture portion is formed so as to be integrated with the exterior member.

11. The electric storage device according to claim 10, wherein the fastening fixture portion is formed by using a portion of the exterior member.

12. The electric storage device according to claim 11, wherein the fastening fixture portion has a fastening hole for fastening the fastening member, and the fastening hole is provided with a sleeve.

13. The electric storage device according to claim 1, further comprising a fastening fixture portion for fastening and fixing the electric storage device,
wherein the fastening fixture portion is formed by a metal bracket.

14. The electric storage device according to claim 1, wherein an electrode terminal of the electric storage body is protruded outside the exterior member, and the reinforcement member is provided so as not to interfere with the electrode terminal.

15. The electric storage device according to claim 1, wherein a voltage detection terminal that detects a voltage of the electric storage element is protruded outside the exterior member, and the reinforcement member is provided so as not to interfere with the voltage detection terminal.

16. The electric storage device according to claim 1, wherein the electric storage body is for use in a vehicle.

17. The electric storage device according to claim 1, wherein the elastic member is made of a rubber.
